(19) United States
(12) Patent Application Publication
(10) Pub. No.: US 2026/0085650 A1
(43) Pub. Date: Mar. 26, 2026

(54) DUAL FUEL INJECTOR AND METHOD

(71) Applicant: Caterpillar Inc., Peoria, IL (US)

(72) Inventors: Cory A. Brown, Peoria, IL (US); Jack Albert Merchant, West Lafayette, IN (US); Hoisan Kim, Dunlap, IL (US)

(73) Assignee: Caterpillar Inc., Peoria, IL (US)

(21) Appl. No.: 18/897,984

(22) Filed: Sep. 26, 2024

(51) Int. Cl. F02M 43/04; F02M 61/04

(52) U.S. Cl. CPC F02M 43/04; F02M 61/042

(57) ABSTRACT

A fuel injector for a dual fuel system includes an injector housing, and a dual concentric check assembly in the injector housing and including an inner check movable to open and close a first nozzle outlet, and an outer check movable to open and close a second nozzle outlet. A fuel flow clearance is defined between the inner check and the outer check for supplying the first fuel to a first nozzle outlet. A tight guide clearance is defined between the inner check and the outer check, and a tight guide clearance is defined between the outer check and the injector housing. A plurality of fuel supply orifices extend through the inner check to fluidly connect a fuel inlet to the fuel flow clearance. The fuel injector may function to inject two different liquid fuels, such as methanol and diesel. Related apparatus and methodology is also disclosed.

### TECHNICAL FIELD

The present disclosure relates generally to a dual fuel system, and more particularly to an arrangement of guide clearances and fuel passages in a fuel injector having a dual concentric check assembly.

### BACKGROUND

Dual fuel systems are well-known and widely used throughout the world in a variety of internal combustion engine applications. Engineers have developed a number of different strategies over the years enabling an engine to operate on a first fuel, a second fuel, a blend of a first fuel and a second fuel, and in some implementations even more than two fuel types.

Dual fuel engines that operate using a relatively small pilot charge of a compression-ignition liquid fuel to ignite a larger main charge of a direct-injected, port-injected, or fumigated gaseous fuel have been commercially available for decades. In recent years, engineering efforts have been increasingly directed at dual liquid fuel strategies such that the engine can operate at least predominantly on one or the other of two liquid fuel types, and sometimes blends, depending upon application and performance requirements. The multiple different fuel types will typically have different properties such as levels of certain emissions when combusted, energy density, or differ with regard to other factors such as availability, cost, and/or handling and storage requirements. Efforts have been underway for some time to commercialize strategies relating to a direct-injected pilot charge of a compression-ignition liquid fuel that ignites a larger main charge of a second, directly injected liquid or gaseous fuel.

Single-fuel engines have long been known that employ a so-called “common rail” or other pressurized fuel reservoir to store a volume of fuel at an injection pressure. Fuel injectors fluidly connected to the common rail can be actuated to reliably inject the stored pressurized fuel. Dual fuel common rail engine platforms are known which provide two dedicated common rails for different fuel types. Pressurizing and storing a relatively large volume of even one type of fuel creates containment challenges among other considerations, requiring robust and costly hardware, seals, and costly monitoring and/or control equipment, and as well as more generally presenting harsh operating conditions. Attempting to provide two separate subsystems for two fuels of course compounds these challenges.

Other challenges that have been observed in dual fuel applications can relate to difficulty in providing sufficient flow of one or the other of the multiple fuels to accommodate load demands of an engine and/or rapidly switching between fuels during service. Certain fuel injector designs also have limited available packaging space for movable components, passages, cavities, and the like, often requiring complex and expensive designs or performance and/or controllability penalties to produce a functional fuel injector. Despite much promise in this technical field, there remain a number of obstacles heretofore limiting the development of dual fuel systems to their full theoretical potential. One known dual fuel engine strategy is set forth in United States Patent Application Publication No. 20240044308A1 to Schroeder et al.

### SUMMARY

In one aspect, a fuel injector includes an injector housing defining a longitudinal axis and forming a first fuel inlet for a first fuel, and a second fuel inlet for a second fuel. The fuel injector further includes a dual concentric check assembly having an inner check movable to open and close a first nozzle outlet, and an outer check movable to open and close a second nozzle outlet. The fuel injector also includes a fuel flow clearance defined between the inner check and the outer check and forming a nozzle supply passage for conveying the first fuel between the first fuel inlet and the first nozzle outlet, a tight guide clearance defined between the inner check and the outer check, and a fuel supply orifice extending through the inner check to fluidly connect the first fuel inlet to the fuel flow clearance.

In another aspect, a fuel system includes a first high pressure fuel conduit, a second high pressure fuel conduit, and a fuel injector forming a first fuel inlet fluidly connected to the first high pressure fuel conduit, a second fuel inlet fluidly connected to the second high pressure fuel conduit, and a second nozzle outlet, and including a dual concentric check assembly having an inner check and an outer check. A fuel flow clearance is defined between the inner check and the outer check and forms a first nozzle supply passage extending between the first fuel inlet and the first nozzle outlet. A second nozzle supply passage is formed in the fuel injector and extends between the second fuel inlet and the second nozzle outlet, and a tight guide clearance is defined between the inner check and the outer check.

In still another aspect, a method of operating a fuel system includes lifting an inner check in a dual concentric check assembly in a fuel injector to open a first nozzle outlet to inject a first fuel, and lifting an outer check in a dual concentric check assembly in the fuel injector to open a second nozzle outlet to inject a second fuel. The method further includes guiding the inner check during the lifting the inner check via a tight guide clearance defined between the inner check and the outer check, and guiding the outer check during the lifting the outer check via a tight guide clearance defined between the outer check and an injector housing of the fuel injector. The method still further includes feeding the first fuel through a fuel supply orifice formed in the inner check to a fuel flow clearance defined between the inner check and the outer check and forming a nozzle supply passage to the first nozzle outlet.

### BRIEF DESCRIPTION OF DRAWINGS

FIG. 1 is a diagrammatic view of a dual fuel internal combustion engine system, according to one embodiment;

FIG. 2 is a sectioned side diagrammatic view of a dual fuel injector, according to one embodiment;

FIG. 3 is another sectioned side diagrammatic view of the dual fuel injector of FIG. 2;

FIG. 4 is yet another sectioned side diagrammatic view of the dual fuel injector as in FIGS. 2 and 3;

FIG. 5 is a diagrammatic view of a tip piece for a dual fuel injector, according to one embodiment;

FIG. 6 is a diagrammatic view of a spacer for a dual fuel injector, according to one embodiment; and

FIG. 7 is a side diagrammatic view of a check for a dual fuel injector, according to one embodiment.

### DETAILED DESCRIPTION

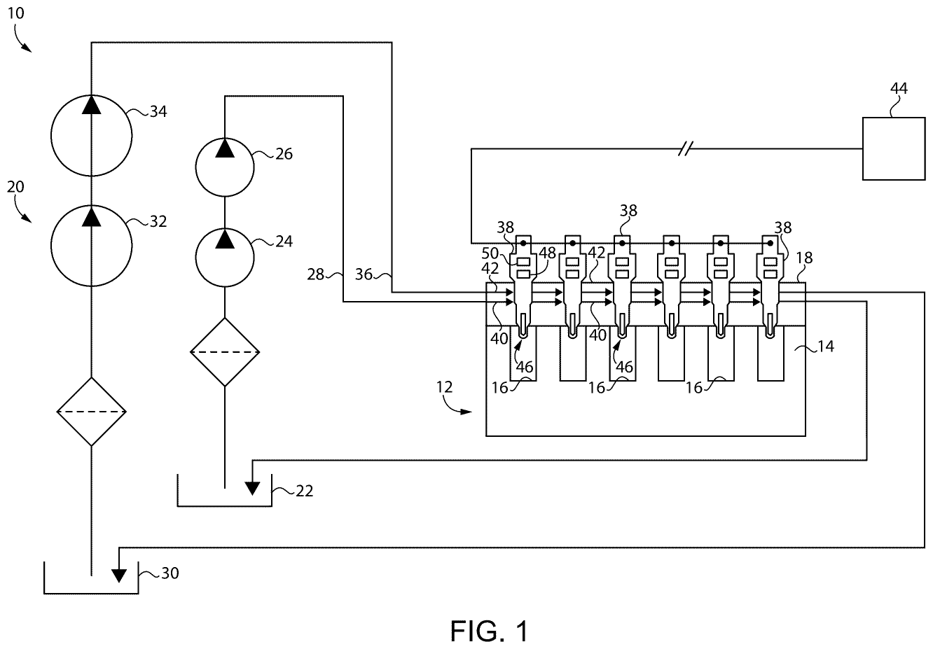

Referring to FIG. 1, there is shown a dual fuel internal combustion engine system 10, according to one embodiment. Engine system 10 includes a dual fuel internal combustion engine 12 having a cylinder block 14 with a plurality of cylinders 16 formed therein. A cylinder head 18 is attached to cylinder block 14. Cylinders 16 can include any number of cylinders in any suitable arrangement, such as an in-line pattern, a V-pattern, or still another. Pistons will be conventionally positioned in cylinders 16 and each movable in a generally conventional manner between a top-dead-center position and a bottom-dead-center position. Engine system 10 can be implemented in a variety of applications including, for example, powering a pump, a compressor, or a driveline in a land vehicle or a marine vessel.

Engine system 10 further includes a dual fuel system 20. Fuel system 20 includes a first fuel supply 22, and a first fuel transfer pump 24 arranged to transfer a first liquid fuel contained in first fuel supply 22 to a high-pressure pump 26. High-pressure pump 26 pressurizes the first fuel to an injection pressure and feeds the same to a first pressurized fuel reservoir 28, such as a common rail. Fuel system 20 also includes a second fuel supply 30, and a transfer pump 32 arranged to transfer a second fuel contained in second fuel supply 30 to a high-pressure pump 34. High-pressure pump 34 pressurizes the second fuel and feeds to same to a second pressurized fuel reservoir 36, such as another common rail. Each of the first fuel and the second fuel may be a liquid fuel.

In an implementation, the first fuel includes a compression-ignition fuel, such as a diesel distillate fuel, and the second fuel includes an alcohol fuel such as methanol, ethanol, or various blends. In other embodiments the first fuel might include a lower cetane number fuel blended with a cetane enhancer, and the second fuel could include that same fuel without a cetane enhancer. In still other examples the first fuel includes JP8 or similar compression-ignition fuels. The second fuel could also include gasoline, naphtha, or various others including liquid fuel blends or gaseous fuels such as liquified natural gas (LNG), methane, ethane, or still others. The two different fuels will typically include liquid fuels varying relative to one another with respect to fuel type/composition, blend ratio, or in some embodiments differing merely with regard to fuel pressure. Fuel system 20 also includes a high-pressure fuel conduit 30 and a second high-pressure fuel conduit 42 fluidly connected, respectively, to first pressurized fuel reservoir 28 and to second pressurized fuel reservoir 36.

Each of high-pressure fuel conduit 40 and high-pressure fuel conduit 42 can include one of a respective plurality of high-pressure fuel conduits. One or both of high-pressure fuel conduit 40 and high pressure fuel conduit 42 includes a so-called quill connector in some embodiments, supported in cylinder head 18. Fuel system 20 also includes a plurality of fuel injectors 38. Fuel injectors 38 each receive a feed of the first fuel at an injection pressure via a respective first high-pressure fuel conduit 40, and a feed of the second fuel at an injection pressure via a respective second high-pressure fuel conduit 42. Each of fuel injectors 38, referred to hereinafter, at times, in the singular, includes a direct injector extending into a respective one of cylinders 16.

Fuel injector 38 includes a nozzle assembly 46 positioned in the respective cylinder 16, a first injection control valve assembly 48, and a second injection control valve assembly 50. First injection control valve assembly 48 is operable in a generally known manner to control injection of the first fuel via nozzle assembly 46 into the respective cylinder 16 according to known techniques. Second injection control valve assembly 50 is operable also according to generally known techniques to control an injection of the second fuel via nozzle assembly 46 into the respective cylinder 16. Injection control valve assemblies 48 and 50 may be electrically actuated, such as solenoid actuated, by way of an electronic control unit or ECU 44.

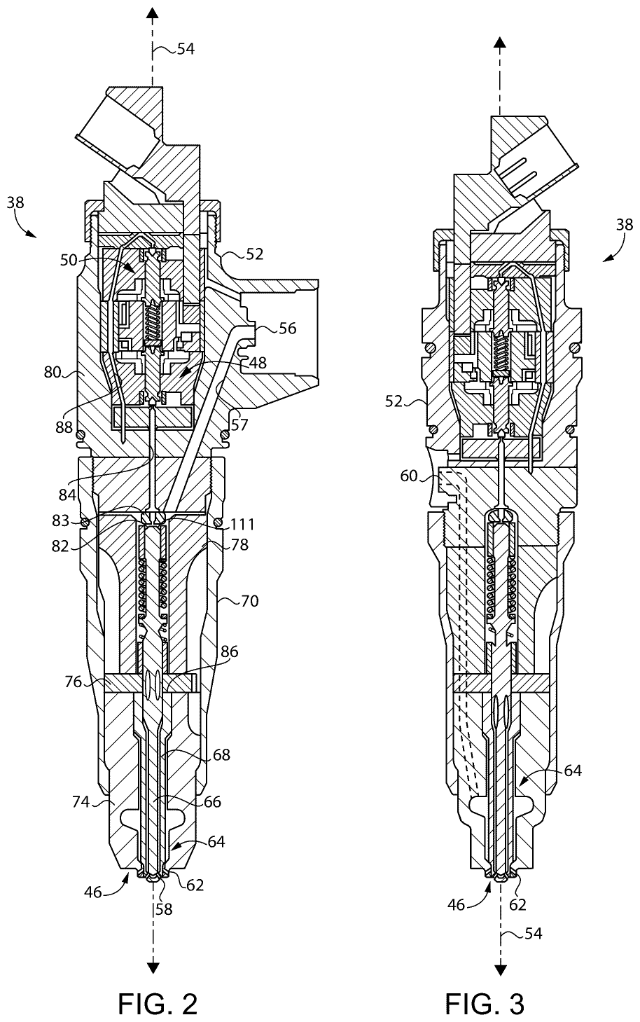

Referring also now to FIGS. 2 and 3, fuel injector 38 includes an injector housing 42 defining a longitudinal axis 54. Injector housing 52 forms a first fuel inlet 56 extending to a first nozzle outlet 58 for the first fuel, and a second fuel inlet 60 extending to a second nozzle outlet 62 for the second fuel. Nozzle assembly 46 includes a dual concentric check assembly 64 having an inner check 66 movable to open and close first nozzle outlet 58, and an outer check 68 movable to open and close second nozzle outlet 62.

In the illustrated embodiment, injector housing 52 includes a casing 70 and a stack 72 clamped in casing 70. Stack 72 may include a plurality of stack pieces, including a tip piece 74, a spacer 76, a spring piece 78, and an injector body 80 threaded engaged with casing 70 to clamp stack 72 in place. Also in the illustrated embodiment, first nozzle outlet 58 is formed in outer check 68, and second nozzle outlet 62 is formed in tip piece 74. Inner check 66 includes a closing hydraulic surface 82 exposed to a fluid pressure of the first fuel conveyed into first fuel inlet 56 through a fuel passage 57 and through an orifice piece 83. A drain passage 84 extends through injector body 80 to injection control valve assembly 48. Outer check 68 includes a closing hydraulic surface 86 exposed to a fluid pressure of the first fuel conveyed into first fuel inlet 56, and as further discussed herein. A drain 88 extends through spacer 76, spring piece 78, and injector body 80 to injection control valve assembly 50.

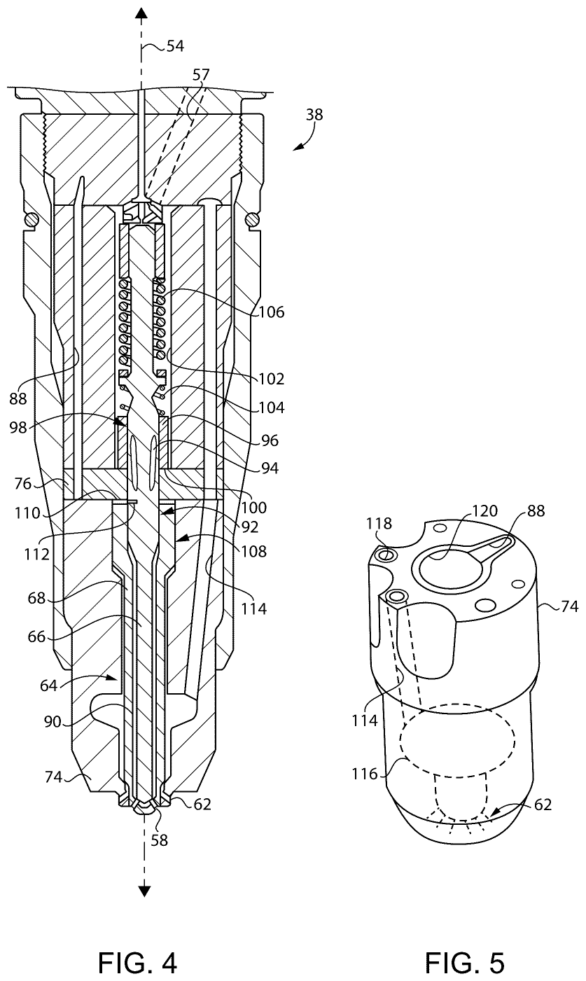

Referring also now to FIG. 4, a fuel flow clearance 90 is defined between inner check 66 and outer check 68 and forms a nozzle supply passage for conveying the first fuel between first fuel inlet 56 and first nozzle outlet 58. A first tight guide clearance 92 is also defined between inner check 66 and outer check 68. It will be appreciated that “a fuel flow clearance” forming a nozzle supply passage as contemplated herein means a relatively larger clearance between the respective parts capable of conveying fuel in quantities sufficient for injection. A “tight guide clearance” as contemplated herein means a smaller clearance, too small to be capable of conveying a sufficient quantity of fuel for injection. In a practical implementation a tight guide clearance provides a clearance small enough so as to effectively form a seal during operation. A clearance between parts that is of sufficient size to permit fuel flow for injection or that varies in size so as to provide for fuel flow between parts is not a tight guide clearance as contemplated. A fuel supply orifice 94 may also extend through inner check 66 to fluidly connect first fuel inlet 56 to the nozzle supply passage formed by fuel flow clearance 90. Fuel supply orifice 94 may be one of a plurality of fuel supply orifices extending through inner check 66 as further discussed herein.

Injector housing 52 also may include stack 72 as discussed above. Injector housing 52 may also include a guide piece 96 in stack 72, and a second tight guide clearance 98 is defined between inner check 66 and guide piece 96. In the illustrated embodiment, guide piece 96 includes a guide sleeve separate from the plurality of stack pieces of stack 72. A metal-to-metal, flat face seal 100 may be formed by guide piece 96 and one of the plurality of stack pieces, in the illustrated embodiment spacer 76. Guide piece 96 may be biased into contact with spacer 76 so as to form the flat face seal 100. A spring chamber 102 is also formed in stack 72, as illustrated formed in spring piece 78. Spring chamber 102 will typically be fluidly connected to first fuel inlet 56, and fluidly connected to fuel flow clearance 90 by way of one of more fuel supply orifices 94.

A spring 104 is disposed in spring chamber 102 and applies a biasing force upon guide piece 96 to establish and maintain face seal 100. In the illustrated embodiment spring 104 is captive between inner check 66 and guide piece 96. A second spring 106 is also disposed in spring chamber 102 and applies a downward closing biasing force to inner check 66 to maintain first nozzle outlet 58 closed when fuel is not being injected. Inner check 66 extends into spring chamber 102, and fuel supply orifice 94 fluidly connects spring chamber 102 to fuel flow clearance 90 as noted.

Each of first tight guide clearance 92 and second tight guide clearance 98 may be formed axially between spring chamber 102 and fuel flow clearance 90. Fuel injector 38 may also include a third tight guide clearance 108 defined between outer check 68 and one of the plurality of stack pieces, as illustrated tip piece 74.

As noted above, inner check 66 includes closing hydraulic surface 82. Outer check 68 may include a closing hydraulic surface 86 as also noted above, exposed to a control chamber 110 formed in injector housing 52. Fuel injector 38 may further include a fill orifice 112 formed in inner check 66 and fluidly connecting fuel supply orifice 94 to control chamber 110.

Referring also now to FIG. 5, there are shown additional features of tip piece 74, including a central bore 120 that receives dual concentric check assembly 64 and forms tight guide clearance 108 with outer check 68. A second nozzle supply passage 114 extends through injector housing 52 between second fuel inlet 60 and second nozzle outlet 62, and circumferentially around outer check 68. A fuel annulus 116 is shown in FIG. 5 and will be understood to extend circumferentially around outer check 68. Fuel annulus 116 may be located axially between tight guide clearance 92 and each of first nozzle outlet 58 and second nozzle outlet 62. In an embodiment, the second fuel may be capable of flowing axially upward around outer check 68 to tight guide clearance 108. A second nozzle supply passage 118 is also shown in FIG. 5 and extends generally fluidly in parallel with nozzle supply passage 114 to fuel annulus 116.

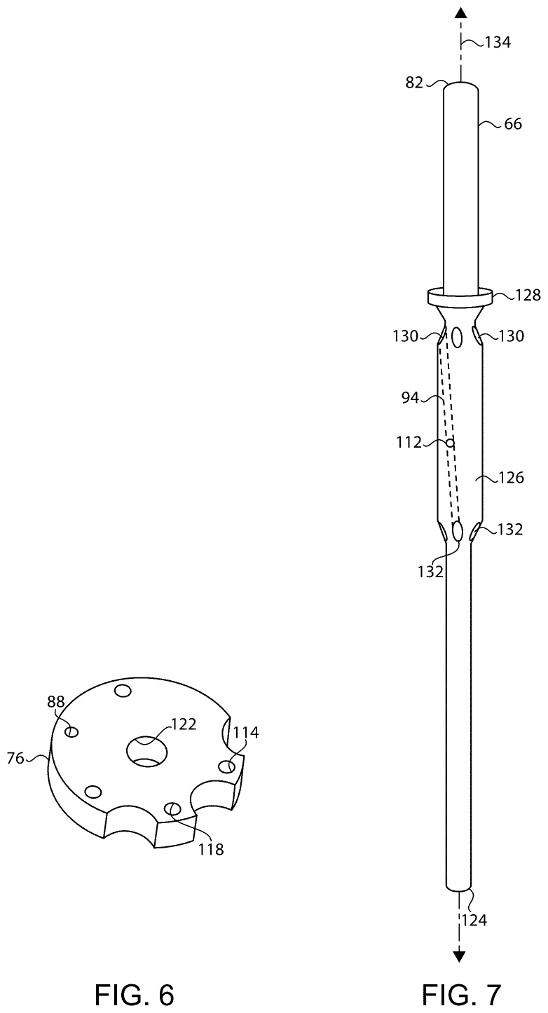

Referring also now to FIG. 6, there are shown additional features of stack piece or spacer 76. Spacer 76 includes a central bore 122 that receives inner check 66. It will be appreciated that flat metal-to-metal face seal 100 with guide piece 96 is formed circumferentially around central bore 122. Spacer 76 also forms a portion of drain 88 that will be understood to fluidly connect to control chamber 110. Nozzle supply passages 114 and 118 also extend through spacer 76.

Referring also now to FIG. 7, it will be recalled that a fuel supply orifice 94 formed in inner check 66 may be one of a plurality of fuel supply orifices formed in inner check 66. Inner check 66 includes a check tip 124 positioned opposite to closing hydraulic surface 82 and defines a check axis 134. Each respective one of the plurality of fuel supply orifices 94 includes an inlet hole 130, and an outlet hole 132 circumferentially offset from the respective inlet hole 130. Fuel supply orifices 94 may be spaced circumferentially around check axis 134 and each oriented so as to extend angularly through inner check 66 to circumferentially offset the respective inlet hole 130 and outlet hole 132. Also in the illustrated embodiment, inner check 66 includes an enlarged central portion 126 wherein fuel supply orifices 94 are formed. A spring shoulder 128 may be located between enlarged central portion 126 and closing hydraulic surface 82 and is positioned between first spring 104 and second spring 106 when inner check 66 is installed in fuel injector 38.

FIG. 7 also illustrates fill orifice 112 fluidly connected to one of fuel supply orifices 94 and extending radially outward so as to provide a fluid connection to control chamber 110. Referring back briefly to FIG. 2, fuel injector 38 also includes another control chamber 111, and closing hydraulic surface 82 is exposed to a fuel pressure of control chamber 111. Spring chamber 102 may be fluidly connected to each of control chamber 110 and control chamber 111.

### INDUSTRIAL APPLICABILITY

Referring to the drawings generally, operating fuel system 20 can include lifting inner check 66 in dual concentric check assembly 64 and fuel injector 38 to open first nozzle outlet 58 to inject the first fuel. Operating fuel system 20 can further include lifting outer check 68 in check assembly 64 in fuel injector 38 to open second nozzle outlet 62 to inject the second fuel. Each of first nozzle outlet 58 and second nozzle outlet 62 may include a plurality of spray offices having circumferential distributions around longitudinal axis 54. During lifting inner check 66, inner check 66 is guided via tight guide clearance 92 defined between inner check 66 and outer check 68 and via tight guide clearance 98 defined between guide piece 96 and inner check 66. During lifting outer check 68 outer check 68 is guided via tight guide clearance 108 defined between outer check 68 and injector housing 52, namely, tip piece 74. The first fuel to be injected can be fed through fuel supply orifice(s) 94 formed in inner check 66 to fuel flow clearance 90. The second fuel to be injected can be fed through nozzle supply passage 114 and potentially also nozzle supply passage 118.

It will be appreciated that injection of the first fuel and injection of the second fuel can be started at desired timings by operating the respective injection control valves 48 and 50, to relieve closing hydraulic pressure on the respective closing hydraulic surface 82 and 86. In particular, energizing injection control valve 48 can fluidly connect control chamber 111 via drain 84 to a low pressure space inside fuel injection 38, or potentially outside fuel injector 38, enabling the high pressure first fuel within fuel injector 38 to urge open inner check 66. Generally analogously, operating injection control valve assembly 50 can cause a reduction in pressure in control chamber 110 by connecting drain 88 to a low pressure space, enabling the high pressure second fuel within fuel injector 38 to urge open outer check 68. To restore fuel pressure to control chamber 110 and end injection, injection control valve assembly 50 is deenergized to block drain 88 from low pressure, permitting high-pressure fuel from fuel supply orifice 94 to repressurize control chamber 110 via fill orifice 112. Restoring fuel pressure to control chamber 111 takes place generally analogously by deenergizing injection control valve 48.

It is contemplated that fuel system 20 can be operated in multiple different modes. In a dual fuel operating mode the injection of the first fuel and the injection of the second fuel may take place in the same engine cycle. For example, a relatively small injection of diesel or another compression-ignition fuel can be performed by the lifting of inner check 66, and a relatively larger main injection of the second fuel such as methanol performed by way of the lifting of outer check 68. The diesel fuel compression-ignites to cause ignition of the larger charge of methanol. In a so-called diesel-only mode only inner check 66 may be operated in a given engine cycle so that engine system 10 is operating solely on diesel fuel.

It is also contemplated that the provision of fuel supply orifice(s) 94 through inner check 66 permits a relatively large flow of diesel for injection in the so-called diesel mode whilst also providing for such functionality in a relatively tight packaging space. The one or more fuel flow orifices 94 can be understood as analogous to a so-called “M-orifice” as the term is known in the art. Fill orifice 112 fluidly connects to fuel supply orifice 94 as discussed above and provides functionality generally similar to that of a so-called “F-orifice” as the term is known in the art. Meanwhile, during service the tight guide clearances as discussed herein can assist in providing fluid sealing and separation of the two fuels, as well as isolating different cavities in fuel injector 38 that are intended, at least at times, to have different pressures.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more. ” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A fuel injector comprising:
an injector housing defining a longitudinal axis and forming a first fuel inlet for a first fuel, and a second fuel inlet for a second fuel;
a dual concentric check assembly including an inner check movable to open and close a first nozzle outlet for the first fuel, and an outer check movable to open and close a second nozzle outlet for the second fuel;
a fuel flow clearance defined between the inner check and the outer check and forming a nozzle supply passage for conveying the first fuel between the first fuel inlet and the first nozzle outlet;
a tight guide clearance defined between the inner check and the outer check; and
a fuel supply orifice extending through the inner check to fluidly connect the first fuel inlet to the fuel flow clearance.

2. The fuel injector of claim 1 wherein the injector housing further includes a stack having a plurality of stack pieces, a guide piece in the stack, and a tight guide clearance defined between the inner check and the guide piece.

3. The fuel injector of claim 2 wherein the guide piece includes a guide sleeve separate from the plurality of stack pieces, and further comprising a metal-to-metal face seal formed by the guide sleeve and one of the plurality of stack pieces.

4. The fuel injector of claim 2 further comprising a spring chamber formed in the stack and fluidly connected to the first fuel inlet, and wherein the inner check extends into the spring chamber and the fuel supply orifice fluidly connects the spring chamber to the fuel flow clearance.

5. The fuel injector of claim 4 wherein each of the tight guide clearance defined between the inner check and the outer check and the tight guide clearance defined between the outer check and the stack piece is formed axially between the spring chamber and the fuel flow clearance.

6. The fuel injector of claim 2 further comprising a tight guide clearance defined between the outer check and one of the plurality of stack pieces.

7. The fuel injector of claim 1 wherein the outer check includes a closing hydraulic surface exposed to a control chamber formed in the injector housing, and further comprising a fill orifice formed in the inner check and fluidly connecting the fuel supply orifice to the control chamber.

8. The fuel injector of claim 1 wherein the fuel supply orifice is one of a plurality of fuel supply orifices formed in the inner check.

9. The fuel injector of claim 8 wherein the plurality of fuel supply orifices each include an inlet hole, and an outlet hole circumferentially offset from the respective inlet hole.

10. The fuel injector of claim 1 wherein a second nozzle supply passage extends through the injector housing between the second fuel inlet and the second nozzle outlet, and circumferentially around the outer check at a location axially between the tight guide clearance and each of the first nozzle outlet and the second nozzle outlet.

11. A fuel system comprising:
a first high pressure fuel conduit;
a second high pressure fuel conduit;
a fuel injector forming a first fuel inlet fluidly connected to the first high pressure fuel conduit, a first nozzle outlet, a second fuel inlet fluidly connected to the second high pressure fuel conduit, and a second nozzle outlet, and including a dual concentric check assembly having an inner check and an outer check;
a fuel flow clearance is defined between the inner check and the outer check and forms a first nozzle supply passage extending between the first fuel inlet and the first nozzle outlet;
a second nozzle supply passage is formed in the fuel injector and extends between the second fuel inlet and the second nozzle outlet; and
a tight guide clearance is defined between the inner check and the outer check.

12. The fuel system of claim 11 further comprising a first pressurized fuel supply fluidly connected to the first fuel supply conduit, and a second pressurized fuel supply fluidly connected to the second fuel supply conduit, and at least one of the first high pressure fuel conduit or the second high pressure fuel conduit includes a quill connector.

13. The fuel system of claim 11 further comprising a tight guide clearance defined between the outer check and an injector housing of the fuel injector, and a tight guide clearance defined between a guide piece in the injector housing and the inner check.

14. The fuel system of claim 11 wherein a plurality of fuel supply orifices extending to the fuel flow clearance are formed in the inner check.

15. The fuel system of claim 11 wherein the inner check includes a closing hydraulic surface exposed to a fluid pressure of a control chamber formed in the fuel injector and fluidly connected to the first fuel inlet, and the outer check includes a closing hydraulic surface exposed to a fluid pressure of another control chamber formed in the fuel injector.

16. The fuel system of claim 15 wherein a spring chamber is formed in the fuel injector, and each of the control chamber and the another control chamber is fluidly connected to the spring chamber.

17. The fuel system of claim 15 further comprising a fill orifice to the another control chamber formed in the inner check.

18. A method of operating a fuel system comprising:
lifting an inner check in a dual concentric check assembly in a fuel injector to open a first nozzle outlet to inject a first fuel;
lifting an outer check in the dual concentric check assembly in the fuel injector to open a second nozzle outlet to inject a second fuel;
guiding the inner check during the lifting the inner check via a tight guide clearance defined between the inner check and the outer check;
guiding the outer check during the lifting the outer check via a tight guide clearance defined between the outer check and an injector housing of the fuel injector; and
feeding the first fuel through a fuel supply orifice formed in the inner check to a fuel flow clearance defined between the inner check and the outer check and forming a nozzle supply passage to the first nozzle outlet.

19. The method of claim 18 further comprising guiding the inner check during the lifting the inner check via a tight guide clearance defined between the inner check and a guide sleeve forming a metal-to-metal face seal with a stack piece in a stack in the fuel injector.

20. The method of claim 18 further comprising ending the injection of the second fuel via restoring a closing hydraulic pressure on a closing hydraulic surface of the outer check through a fill orifice formed in the inner check.
